(19) United States
(12) Patent Application Publication
(10) Pub. No.: US 2001/0028202 A1
(43) Pub. Date: Oct. 11, 2001

(54) Stator winding for a variable speed brushless direct current (DC) Motor

(76) Inventor: Xianzhen Chen, North York (CA)

Correspondence Address: SWABEY OGILVY RENAULT, SUITE 1600, 1981 MCGILL COLLEGE AVENUE, MONTREAL, QC, H3A2Y3, CA

(21) Appl. No.: 09/810,500

(22) Filed: Mar. 19, 2001

(30) Foreign Application Priority Data
Apr. 5, 2000 (CN) ZL00229603.9

(51) Int. Cl. H02K 23/02; H02K 19/26

(52) U.S. Cl. 310/189; 310/184; 310/180

(57) ABSTRACT

A stator winding is divided into segments enabling the stator current to be controlled to flow within a selected portion of the stator winding. The number of “active” turns of the stator winding, that is, the number of turns in which stator current is flowing, determines the motor performance, and thus the speed range over which the motor will operate efficiently. The overall speed range of the motor can be extended by selectively connecting a power supply across one or more segments to thereby dynamically adjust the number of “active” turns of the stator winding. A permanent magnet brushless DC motor incorporating the stator winding of the present invention can be designed having an overall performance characteristic that is similar to that of a series polar direct current motor. It has a higher torque at low speeds, providing good starting and climbing performance of a vehicle incorporating such a motor. The motor can operate efficiently at moderate and high speeds, and can be controlled using a simple control system, thereby enabling simplified operation of an electric vehicle incorporating the motor.

### CROSS-REFERENCE TO RELATED APPLICATIONS

This application is based on, and claims priority of Chinese Utility Patent Application No. ZL00229603.9, filed on Apr. 5, 2000.

### MICROFICHE APPENDIX

Not Applicable.

### TECHNICAL FIELD

The present invention relates to brushless DC motors, and in particular to a stator winding for a variable speed brushless DC motor.

### BACKGROUND OF THE INVENTION

Conventional permanent magnet brushless DC motors include a permanent magnet rotor magnetically coupled to a stator, which includes at least one stator winding electrically coupled to a power supply. As is known in the art, increasing the number of stator windings has the effect of smoothing the output torque of the motor. Typically, three independently driven stator windings, or phases, are utilized, as a compromise between smooth output torque and efficient design of the power supply and phase driver circuits. Each phase is manufactured having an equal number turns, which is selected based on desired performance characteristics (output speed vs. torque speed) of the motor. As a result, a motor will operate efficiently only within a predetermined range of speed and torque, which is fixed at the time of manufacture of the motor.

In many instances, and in particular for electric vehicles, motors need to operate over a very wide speed range. For example, when a vehicle is starting or climbing up a slope, high torque output at a low speed is required. Medium torque and speed are needed while driving at moderate speeds (e.g. within a city), whereas a high speed (and low torque) is necessary when driving at high speed, such as on a highway. Currently brushless DC motors do not perform satisfactorily over such a broad range of speeds. Typically, if a motor is designed for satisfactory operation at lower speeds, efficient operation at higher speeds is compromised. Similarly, if a motor is designed for satisfactory operation at higher speeds, satisfactory operation is not obtained at a lower speed.

Accordingly, a brushless DC motor capable of operating efficiently over a wide range of speed and torque remains highly desirable.

### SUMMARY OF THE INVENTION

Accordingly, it is an object of the present invention to provide a stator winding for a brushless DC motor that is capable of producing satisfactory motor performance over a wide speed range.

Accordingly, an aspect of the present invention provides a stator winding for a brushless DC motor. The stator winding includes at least two segments having a respective plurality of turns. Each segment includes a respective tap adapted to enable electrical connection of the segment to a power supply.

The number of turns of each segment may be selected based on a desired performance of the motor.

The segments may be electrically connected in series. Preferably, means are provided for electrically connecting a selected one of the taps to the power supply. Thus a stator current can be controlled to flow through a selected one or more of the segments, by connecting a selected one of the taps to the power supply. In such cases, the number of turns of each series connected segment may be selected such that a total number of turns in which the stator current is flowing yields a desired performance characteristic of the motor.

Thus the present invention provides stator winding which is divided into segments such that the stator current can be controlled to flow within a selected portion of the stator winding. The number of “active” turns of the stator winding (that is, the number of turns in which stator current is flowing) determines the motor performance, and thus the speed range over which the motor will operate efficiently. The overall speed range of the motor can thus be extended by selectively connecting a power supply across one or more segments to thereby dynamically adjust the number of “active” turns of the stator winding. A permanent magnet brushless DC motor incorporating the stator winding of the present invention can be designed having an overall performance characteristic that is similar to that of a series polar direct current motor. It has a high torque at low speeds, providing good starting and climbing performance of a vehicle incorporating such a motor. Additionally, the motor can operate efficiently at moderate and high speeds. Finally, the motor can be controlled using a simple control system, thereby enabling simplified operation of an electric vehicle incorporating the motor.

### BRIEF DESCRIPTION OF THE DRAWINGS

Further features and advantages of the present invention will become apparent from the following detailed description, taken in combination with the appended drawings, in which:

FIG. 1 is a schematic diagram illustrating a three-phase stator winding in accordance with an embodiment of the present invention;

FIG. 2 is an exemplary speed vs. torque graph illustrating the performance of a brushless DC motor incorporating a stator winding in accordance with an embodiment of the present invention;

FIG. 3 is a block diagram schematically illustrating connection of a winding phase to a power supply in accordance with an embodiment of the present invention; and

FIG. 4 is a schematic diagram illustrating a four-phase stator winding in accordance with a second embodiment of the present invention.

It will be noted that throughout the appended drawings, like features are identified by like reference numerals.

### DETAILED DESCRIPTION OF THE PREFERRED EMBODIMENT

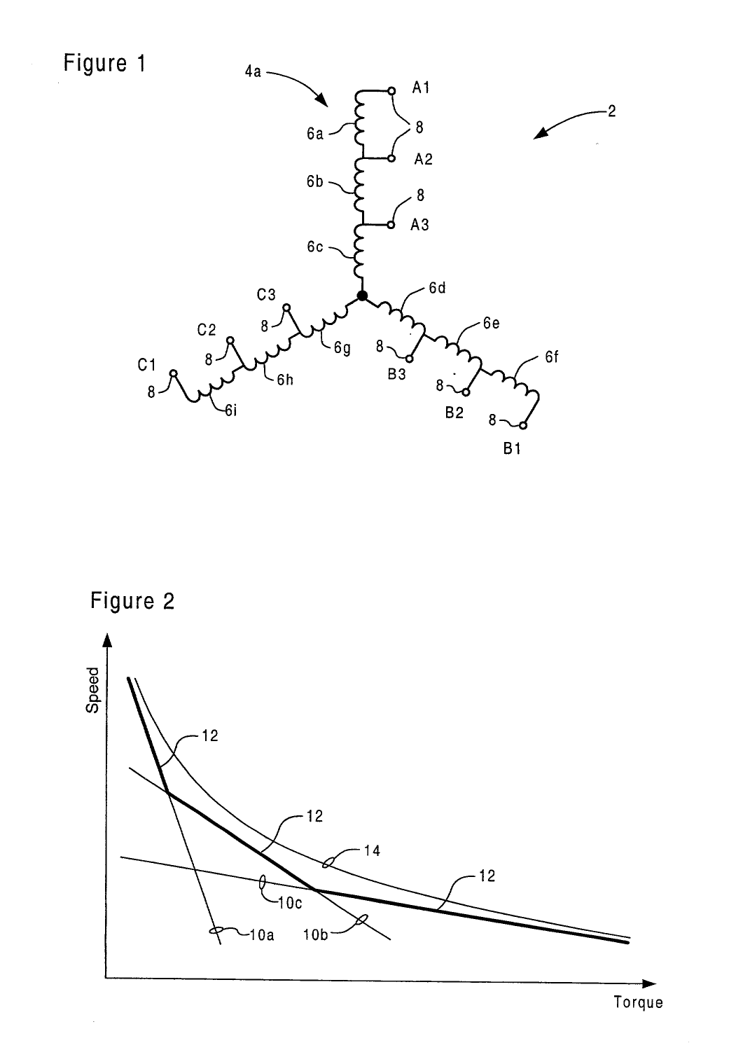

The present invention provides a stator winding of a brushless DC motor, in which the number of active (i.e. current-carrying) turns can be varied as required in order to yield efficient operation of the motor over a wide range of speeds. FIG. 1 illustrates an exemplary stator winding 2 in accordance with an embodiment of the present invention.

In the embodiment of FIG. 1, the stator winding 2 is divided into three phases 4a-4c connected in a so-called star pattern. Those skilled in that art will appreciate that more, or fewer, phases 4 may be provided, and that connection patterns other than a star connection pattern, such as triangle and quadrilateral connection patterns may be utilized. Similarly, those skilled in the art will appreciate that the stator winding may be driven by any suitable DC power supply, which may, if desired, utilize either half wave or full wave rectification.

Each phase 4 is divided into two or more segments 6. Each segment 6 has a predetermined number of turns, and includes a respective tap 8 enabling that segment 6 to be connected to a power supply (not shown) Within a phase 4, each segment 6 may have the same, or a different, number of turns, as may be appropriate for the desired overall performance of the motor. However, corresponding segments 6 in each phase 4 should have the same number of turns. Thus, for example, segment 6a in phase 4a should have the same number of turns as segments 6f and 6i in phases 4b and 4c, respectively. Similarly, segment 6b should have the same number of turns as segments 6e and 6h; while segment 6c should have the same number of turns as segments 6d and 6g. In general, the segments 6 may be connected in series, as shown in FIG. 1, or in parallel, as desired. In either case, the number of turns of each segment 6 is preferably selected based on desired performance characteristics of the motor. In particular, the number of turns of each segment 6 can be suitably selected such that, by connecting the power supply across one or more segments 6, the stator current can be controlled to flow within an appropriate number of active turns to yield efficient motor performance for the speed regime in which the motor is operating. This operation is shown in FIG. 2, which is an exemplary speed vs. torque graph illustrating the performance of a brushless DC motor, in which the number of active turns in each winding phase 4 is varied.

As is known in the art, a small number of active turns yields a motor performance characteristic 1a that is appropriate to a high speed (and low torque) operating regime. Similarly, a moderate number of active turns yields a motor performance characteristic 10b that is appropriate to a moderate-speed (and torque) operating regime, while a high number of active turns yields a motor performance characteristic 10c that is appropriate to a low-speed (and high torque) operating regime. In the present invention, the number of active turns is controlled by selecting the number of turns in each segment 6, and by controlling the number of segments 6 through which the stator current flows. In the embodiment of FIG. 1, each phase 4 of the stator winding is divided into three series connected segments 6. In this case, the stator current can be dynamically controlled to flow through one, two, or all three of the segments 6, in order to yield an overall motor performance characteristic 12 indicated by the bold line in the graph of FIG. 2. It will be seen that this overall motor performance characteristic 12 extends over a far wider range of speeds than could be obtained with conventional brushless DC motors, in which the number of active turns is fixed.

In principle, each phase 4 may be divided into an arbitrary number of segments 6 (each containing at least one turn). The embodiment of FIG. 1 utilizes three segments 6 in each winding phase 4, yielding a corresponding three-segment overall motor performance characteristic 12. It will be appreciated that as the number of segments 6 increases, the overall motor performance characteristic will more closely approximate a smooth curve 14, as is shown in FIG. 2.

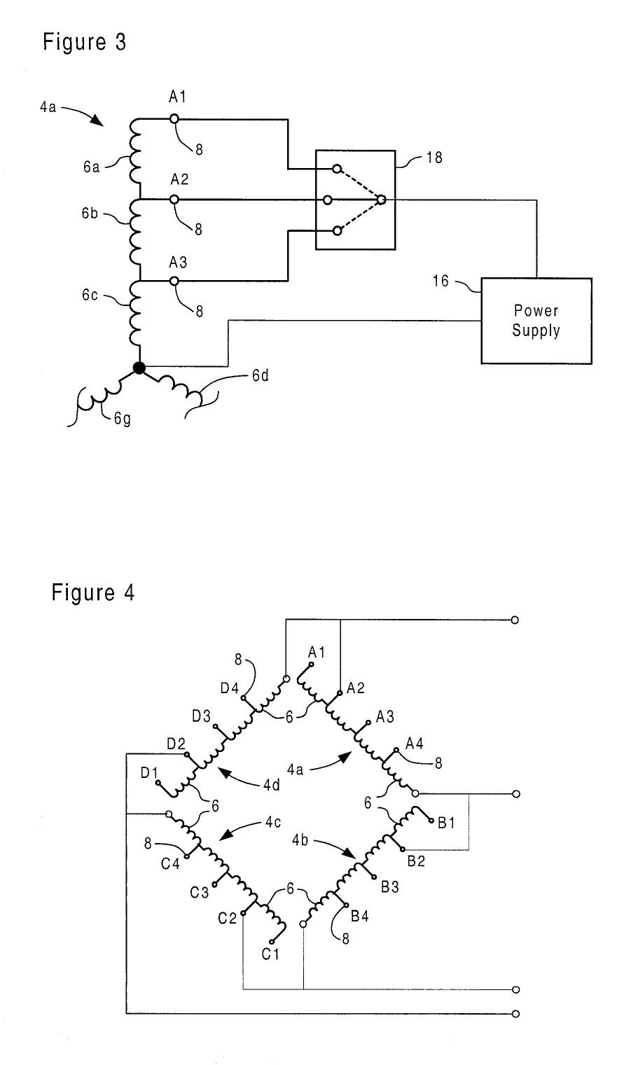

FIG. 3 is a block diagram schematically illustrating an exemplary connection between a phase 4a of the stator winding to a DC power supply 16. It will be understood that such a connection arrangement is preferably duplicated for each of the other winding phases 4b,4c such that under all operating conditions, each phase 4 will have an equal number of active turns.

As shown in FIG. 3, each tap 8 is connected to a control unit 18 designed to selectively connect one of the taps to the power supply. Using this arrangement, when tap A1 is connected by the control unit 18 to the power supply 16, stator current flows through all three segments 6a-6c of the phase 4a. Consequently, the number of active turns is maximized, yielding motor performance appropriate for a low speed operating regime. When tap A2 is connected to the power supply 16, stator current flows through segments 6b and 6c of the phase 4a. This results in a medium number of active turns, yielding motor performance appropriate for a medium speed operating regime. Finally, when tap A3 is connected to the power supply, stator current flows through only segment 6c. Thus the number of active turns is minimized, yielding motor performance appropriate for a high speed operating regime.

FIG. 4 is a schematic diagram illustrating a second embodiment of the present invention in which a four-phase stator winding is connected in a quadrilateral pattern. Each winding phase is divided into a plurality of series connected segments. In the illustrated embodiment, each winding phase 4 is divided into four segments 6. It will be seen that the number of active turns in each phase 4 can be controlled by selectively connecting one of the taps 8 from each phase 4 to a power supply, so that stator current flows within a desired one or more segments 6 of each phase 4.

Thus it will be seen that the present invention provides a stator winding which enables the stator current to be controlled to flow within a selected number of active turns of the stator winding. The overall speed range of the motor can therefore be extended by switching the stator current to flow through one or more segments of the stator winding, to thereby dynamically adjust the number of “active” turns of the stator winding.

The embodiment(s) of the invention described above is(are) intended to be exemplary only. The scope of the invention is therefore intended to be limited solely by the scope of the appended claims.

I claim:

1. A stator winding for a brushless DC motor, the stator winding comprising at least two segments having a respective plurality of turns, each segment including a respective tap adapted to enable electrical connection of the segment to a power supply.

2. A stator winding as claimed in claim 1, wherein the number of turns of each segment is selected based on a desired performance of the motor.

3. A stator winding as claimed in claim 1, wherein the segments are electrically connected in series.

4. A stator winding as claimed in claim 3, further comprising means for electrically connecting a selected one of the taps to the power supply, such that a stator current flows through a corresponding selected one or more of the segments.

5. A stator winding as claimed in claim 1, wherein the segments are electrically connected in parallel.

6. A stator winding as claimed in claim 5, further comprising means for electrically connecting a selected one or more of the taps to the power supply, such that a stator current flows through a corresponding selected one or more of the segments.

7. A stator winding as claimed in claim 4 or 6, wherein the number of turns of each segment is selected such that a total number of active turns yields a desired performance of the motor.
